(19) United States
(12) Patent Application Publication
(10) Pub. No.: US 2017/0038075 A1
(43) Pub. Date: Feb. 9, 2017

(54) AIRCRAFT ENGINE COMPRISING AZIMUTH SETTING OF THE DIFFUSER WITH RESPECT TO THE COMBUSTION CHAMBER

(71) Applicant: TURBOMECA, Bordes (FR)

(72) Inventors: Patrick DUCHAINE, Gelos (FR); Claude BERAT, Igon (FR); Christophe Nicolas Henri VIGUIER, Arros de Nay (FR)

(73) Assignee: TURBOMECA, Bordes (FR)

(21) Appl. No.: 15/302,807

(22) PCT Filed: Apr. 7, 2015
(86) PCT No.: PCT/FR2015/050882

§ 371 Date: Oct. 7, 2016

(30) Foreign Application Priority Data
Apr. 9, 2014 (FR) 14 53165

(51) Int. Cl. F23R 3/54; F23R 3/04; B64D 27/10

(52) U.S. Cl. CPC F23R 3/54; B64D 27/10; F23R 3/04

(57) ABSTRACT

The fixed vanes of a diffuser are set to an azimuth angle setting (α) with respect to the injectors of a combustion chamber so that the paths leading from the trailing edges pass through the gaps between injectors and more preferably mid-way between same, so that these portions of the flow, which may contain condensed water, do not affect the initiation of the combustion.

The subject of this invention is an aircraft engine comprising an azimuth setting between the diffuser and the combustion chamber.

The diffusers in question are arranged on the gas flow duct, between the compressors and the combustion chamber, and they consist in one or several circles of fixed vanes, which alter the flow of gases exiting from the compressor by opposing it with curved and concave intrados surfaces, before allowing them to arrive in the combustion chamber. Combustion chambers are described in documents FR-2 881 813-A and FR-2 905 166-A. There are diffusers devoid of the marked property of altering the flow, of which the vanes are axial and straight (FR-2 616 890-A and GB-700 688-A).

The interest here is to prevent accidental extinctions of the combustion chamber, subsequent to the ingestion of water in the engine. This ingestion of water at any phase in aircraft engines can come from various causes, including flight in inclement weather (rain, hail, snow, fog or clouds), high ambient humidity, or gushes of water at takeoff by the wheels (plane) or by the rotor (helicopter). It can substantially modify the operating conditions of the machine, harm combustion and even prevent it entirely by extinguishing the chamber. The extinction can be direct when a large quantity of water suddenly arrives in the combustion chamber, or progressively, with the temperature of the gases decreasing little by little and the combustion taking place more and more poorly.

Among the measures taken to counter these difficulties, takings of air in the compressors have been imagined, in order to withdraw a portion of the air outside the duct, loaded with water by the centrifugation produced by the compressors, and prevent it from reaching the combustion chamber. These takings are however not always sufficient, and also are not provided on all engines. Another means in practice consists in causing the water to stream over a fairing covering the bottom of the combustion chamber and located in front of the diffuser. Such a fairing is also however not always present on all engines, and it can be difficult to optimise if it is added, as there are many parameters to be taken into consideration. It must in any case be pierced, either in order to allow the compressed gas to enter into the combustion chamber between the injectors, or in order to provide other functions: its effectiveness is therefore doubtful with regards to protection against water and moisture.

Recourse here is given to another solution in order to overcome this problem: it is considered here to introduce an azimuth setting between the vanes of the diffuser and the injectors. In other terms, the angular position of the vanes of the diffuser is defined in such a way as to limit the accumulation of water in front of the injectors and have them receive drier air, while still concentrating the water and allowing it to pass between the injectors, therefore without it harming the combustion.

To summarise, the invention relates to an aircraft engine comprising a gas flow duct, a combustion chamber located on the flow duct and a diffuser also located on the flow duct upstream of the combustion chamber. The diffuser is comprised of fixed vanes altering the flow and arranged in a circle. The combustion chamber comprises fuel injectors that have injection orifices arranged in a circle coaxial to the circle of the vanes. It is characterised in that the vanes are arranged angularly with respect to the injectors in such a way that the paths of the flow coming from the trailing edges of the vanes end between the injectors; favourably at middle third angular distances between the injectors; and even more favourably, at a distanced that is angularly mid-way between the injectors.

The diffuser frequently comprises a plurality of successive stages. The invention shall then be applied on the stage of the diffusers that models the most flow downstream, frequently the upstream stage.

The invention is based on water concentrated in the flow passing in front of the intrados of the vanes of the diffuser due to its greater inertia. It is then to be provided that the lines of current, traced from the trailing edge of the vanes, will be all the more so proper for the extinction of the chambers that they pass outside of the injectors, and at a good angular distance between the injectors, or near this mid-way distance. EP-2 123 863-A describes a device with intrados diffuser vanes, which are, taken as a whole, devoid of a favourable azimuth setting, characteristic of the invention.

The invention shall now be described in detail using the following figures:

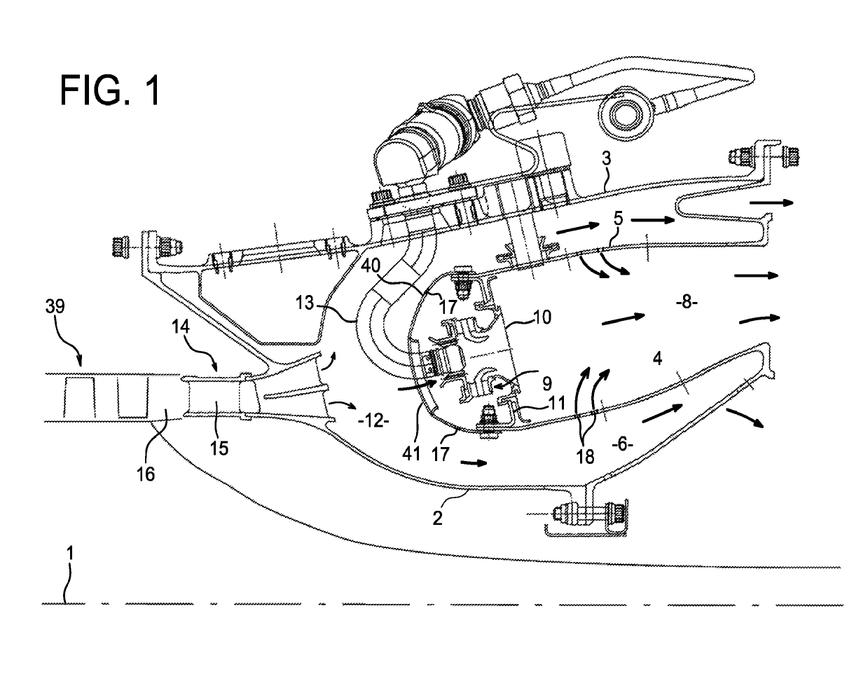

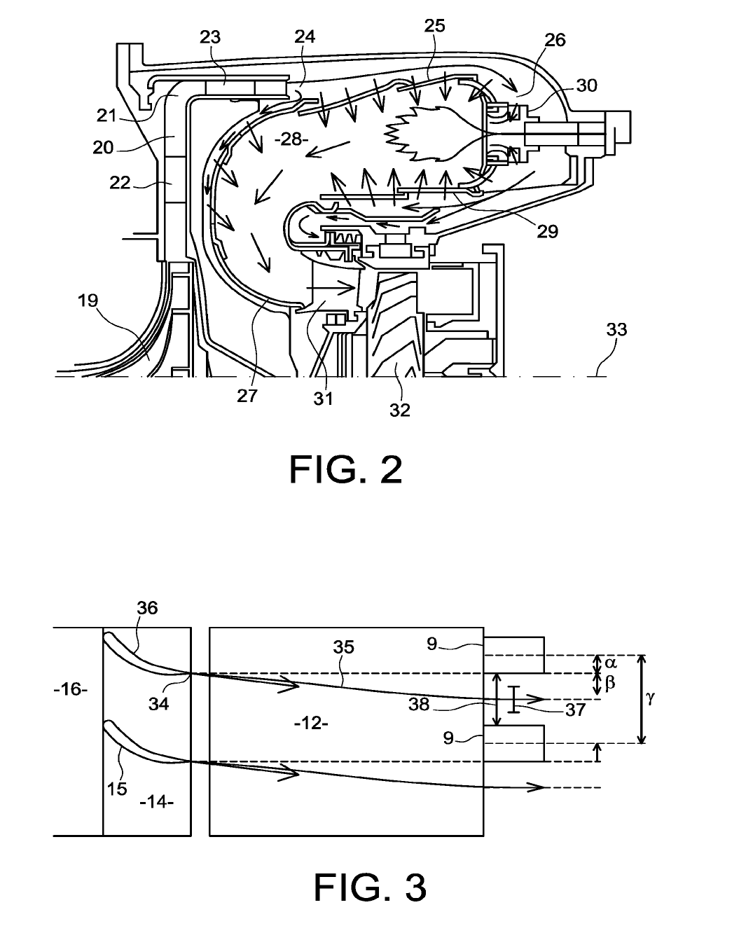

FIGS. 1 and 2 show combustion chambers;

and FIG. 3 shows the invention, as a developed representation on a plane of a portion of the circles of vanes and injectors, with the plane being defined by the axial direction and the angular (azimuth) direction of the machine.

FIG. 1 shows here a typical combustion chamber, comprising, about an central axis 1, an inner casing 2, an outer casing 3, an inner ferrule 4, an outer ferrule 5, an interior by-pass duct 6 between the inner casing and the inner ferrule 4, an exterior by-pass duct 7 between the outer casing 3 and the outer ferrule 5, a combustion chamber 8 between the ferrules 4 and 5, injectors 9 that open via injection orifices 10 into the combustion chamber 8, a bottom wall of the chamber 11 that joins the inner ferrule 4 to the outer ferrule 5, but pierced in order to all the injectors 9 to pass, a diffusion chamber 12 present between the inner casing 2 and the outer casing 3, upstream of the combustion chamber 8 and of the bottom wall of the chamber 11, passed through by pipes 13 for supplying injectors 9 with fuel, and a diffuser 14 at the inlet of the diffusion chamber 12, occupied by fixed vanes 15, arranged in a circle through a duct 16 of a flow of gases coming from the compressors 39. Fairings 40 here cover the injectors 9 to the diffuser 14 from the inner ferrule 4 to the outer ferrule 5; their shape is domed, and they are provided with openings 41 that are rather wide around the pipes 13 and in front of the injectors 9. The air of the duct 16 bypasses, partially, the combustion chamber 8 via the internal 6 and external 7 bypass ducts, and enters therein partially via the openings 41, the orifices 10, and via piercings such as 17 and 18 passing through the ferrules 4 and 5 and possibly the fairing 40 in order to, according to the case, form the combustible mixture with the fuel, contribute to a dilution of this mixture downstream, or refresh the ferrules 4 and 5 by a taking of the cooler air from the bypass ducts 6 and 7, according to the positions of these piercings and of their inclinations for example; very many designs exist in this field.

Another type of combustion chamber shall be mentioned, referred to as inverted flow and shown in FIG. 2. The compressor 19 is here axial or centrifugal, and supplies a duct 20, firstly flat and divergent, passed through by a radial, then annular, flow, after an elbow 21. The diffuser is here comprised of a radial diffuser stage 22 upstream of the elbow 21, then an axial diffuser stage 23, downstream. When exiting the axial diffuser 23, the air ends in a diffusion chamber 24, before bypassing an upstream ferrule 25, on one side or the other, axially in the downstream direction by a first bypass duct 26, or radially outwards by a second bypass duct 27. The upstream ferrule 25 has a curved section rather close to a half-circle. A combustion chamber 28 is present between the upstream ferrule 25 and a downstream ferrule 29, it is also curved and surrounded by the preceding, in such a way that the combustion chamber 28 forms a half-turn return. The fuel injectors 30 are here arranged in such a way as to initiate the combustion at a radially exterior and axially downstream end of the combustion chamber 28, by propelling the fuel towards the upstream of the machine. They do not have here any fairing covering them. The injectors 30 can also be located on the upstream ferrule 25. The combustion gases flow along the combustion chamber 28, carrying out a half-turn radially inwards and axially downstream, before leaving it via a distributor 31, comprised of fixed vanes, in order to reach the turbines 32. The air enters into the combustion chamber 28 through various piercings and openings, in the same way as in the other design. In all of the designs, the diffusers 14, 22 and 23, as well as the injectors 9 and 30, are arranged in circles coaxial to the axis 1 or 33 of the machine.

Reference is made to FIG. 3 for the explanation of the invention, using through commodity the reference of FIG. 1, although the invention can be generalised to other combustion chambers, in particular the one of FIG. 2, as shall be developed hereinbelow. The flow in the diffusion chamber 12 is defined in the angular direction by the shape of the fixed vanes 15 and in particular their inclination to the trailing edge 34. The drops of water have axial speed components and which makes them follow paths 35 that are approximately tangent to this inclination in the diffusion chamber 12. Some have a radial speed component that is sufficient to bypass the combustion chamber 8 by being sufficiently altered by the air currents, but the largest portion is projected via inertia towards the combustion chamber 8, by therefore being able to reach the injectors 9 through the openings 41, even when the fairing 40 exists, and the risk of extinction of the combustion chamber 8 appears, with the moisture moreover also able to enter therein via the piercings 17 and 18. Note that the water will concentrate near the intrados 36 of the fixed vanes 15 due to its inertia; it will much more willingly follow the paths 35 and the vicinities thereof.

In accordance with the invention, the fixed vanes 15 are placed in such a way that the paths 35 pass at a distance from the injectors 9, between them, favourably in the middle third 37 of their gaps 38, and even more favourably in the middle of these gaps 38;

if the angular pitch of the injectors 9 is equal to γ, and the angle of the paths 35 between the trailing edges 34 and the injectors 9 is equal to β, the azimuth setting α, i.e. the angle between the trailing edges 34 and the injectors 9, shall be at best chosen such that

$$α + β = \frac{γ}{2} .$$

The situation is exactly the same for an inverted flow chamber such as that of FIG. 2, considering that the paths 35 are accomplished in the diffusion chamber 34 and in the external bypass duct 26 to the injectors 30.

In the case where the diffuser is composite, such as the one of FIG. 2, the criterion shall apply to the diffuser that is applying the strongest altering, i.e. in general the diffuser which is most upstream, the radial diffuser 22 in the case of FIG. 2; if however the downstream diffuser (the downstream diffuser 23) carried out the strongest altering, this is the one that will be considered.

If necessary, the paths 35 shall be specified by test modeling calculations.

By passing next to the injectors 9 or 30, the water stream along the combustion chamber or bypasses it entirely before moving away from it.

The application of the invention will often depend on clever choices between the number of vanes of the diffuser and that of the injectors: these numbers must often allow for a common divisor, in such a way as to allow for similar arrangements of groups of the vanes in relation to each one of the injectors. An irregular distribution in the angular direction of the vanes can then by chosen, with the vanes being absent where the paths 35 would lead to the injectors 30. In other types of embodiments, the invention can be applied with regards to certain injectors only, which will then be main injectors, with others having a lesser flow rate. With the injectors all being arranged outside of the reach of the paths 35 according to what precedes, irregular distributions of the injectors in angular pitches could also be considered.

Generally, the azimuth setting assumes a “clocking” between the number of vanes of the diffuser and the number of injectors (these two numbers have a common divisor). There are however particular cases for which the “clocking” is not necessary:
in the case where a privileged injector exists (injector supplied preferably during low power speeds), the azimuth setting could be defined in relation to this particular injector;
in the case where the extinction is governed by the penetration of water through the primary holes, the azimuth setting can be defined using these primary holes. In this case here, the numbers of primary holes and vanes must have a common submultiple.

1. An aircraft engine comprising a gas flow duct, a combustion chamber located on the flow duct and a diffuser also located on the flow duct upstream of the combustion chamber, with this diffuser being comprised of fixed vanes provided with an inclination in an angular direction of the engine along an axial direction of the engine, thus provided with an intrados altering the flow and arranged in a circle, with the combustion chamber comprising fuel injectors arranged in a circle coaxial to the circle of the vanes, wherein the vanes are arranged angularly with respect to the injectors in such a way that paths of the flow, coming from the trailing edges of the vanes and of the same angular inclination to said trailing edges, tangent to the intrados of the vanes, end between the injectors.

2. The aircraft engine according to claim 1, wherein the flow lines end at middle thirds of angular distances between the injectors.

3. The aircraft engine according to claim 2, wherein said paths end at angular mid-way distances between the injectors.

4. The aircraft engine according to claim 1, wherein, the diffuser comprising a plurality of successive stages, said vanes belong to one of the stages on the flow duct, with this step applying the strongest altering to the flow.

5. The aircraft engine according to claim 1, wherein the vanes have an irregular distribution in the angular direction of the engine, the vanes being absent where the paths would lead to the injection.
